(19) United States
(12) Patent Application Publication
(10) Pub. No.: US 2019/0120931 A1
(43) Pub. Date: Apr. 25, 2019

(54) Millimeter-wave System-in-Package for Parking Assistance

(71) Applicant: NovelIC d.o.o., Belgrade (RS)

(72) Inventors: Veljko Mihajlovic, Belgrade (RS); Darko Tasovac, Belgrade (RS); Sinisa Jovanovic, Belgrade (RS); Veselin Brankovic, Belgrade (RS)

(73) Assignee: Novelic d.o.o., Belgrade (RS)

(21) Appl. No.: 15/792,068

(22) Filed: Oct. 24, 2017

(51) Int. Cl. G01S 7/03; H01Q 21/08; H01Q 21/00; G06K 9/00; G01S 13/93; G01S 13/90; G01S 13/42; G01S 7/35

(52) U.S. Cl. CPC G01S 7/032; H01Q 21/08; H01Q 21/0075; G06K 9/00536; G01S 2013/9314; G01S 13/90; G01S 13/42; G01S 7/352; G01S 2007/358; G01S 13/931

(57) ABSTRACT

The present invention relates to a parking support Apparatus, comprising mm-wave radar sensor, having an integrated mm-wave IC front end. The proposed Apparatus can detect the parking obstacle object distance and partly position of the objects, having inherently low-cost system topology, suitable as a replacement in functionality for the commonly used ultrasound sensors. Proposed apparatus is preferably realized by integrated low cost module approach, using single metal layer printed dipole antennas, with integrated reflector, and four connectors for digital interface and DC supply, without PCB structures, bonding wires and flip chip bubbles. The proposed Apparatus can be integrated by using reduced complexity module integration with polymers or semiconductor technologies. Proposed Apparatus advantageously introduce reduced complexity single planar shaped metallization layer, comprising antenna radiation elements, feeding networks for antennas and dc supply strip lines for active components in the same metallization plane. The complete proposed Apparatus with integrated antennae, mm-wave IC and digital processing parts may be realized in a module smaller than 3×1,5×0.5 cm, preferably operating in the 77-81 GHz band.

### TECHNICAL FIELD

The present invention relates to a parking assistance system comprising mm-wave radar sensor with specific integrated mm-wave IC Front, specific antenna arrangement, innovative module package for the system, specific position of the innovative system on a vehicle. The proposed Apparatus is capable of detecting the obstacle distance, having inherently low-cost system topology and is suitable as a functional replacement for the commonly used ultrasound sensors. The proposed Apparatus topology consists of specific transmitting and receiving planar antenna systems, mm-wave radar front end being released as radio frequency integrated circuit. The mm-wave radar topology consists of IQ down conversion chain and one transmitter chain based on FMCW radar. Optionally system supports CW radar and Doppler radar operation principles, within the same apparatus. The proposed system has only one printed and shaped metal layer, comprising DC feeding lines, and antenna radiation elements in the same plane with reflection metallization planes, which allows simple manufacturing process, with reduced manufacturing steps, compared to state of art.

### BACKGROUND ART

There is a strong motivation to deploy smart, small, low power consumption and low-cost sensors for vehicle parking support applications, in the following application scenarios and specific features:
a) Detection of obstacle distance at distances beyond 10 m.
b) Operation of the sensors integrated in the bumper or in other vehicle parts, not visible outside the vehicle, as commonly is the case with ultrasound parking systems.
c) Operation of the sensors connected with several identical sensors to provide more robust information for parking assistance.
d) Additional features to detect human or other living beings in the area intended for vehicle parking, with no extra hardware cost.
e) Additional features to detect vehicle vibrations, with no extra hardware cost.
f) Optional operation feature in case of several sensors are integrated in the bumper, to improve obstacle distance and angle accuracy, by processing data from more than one sensor integrated in the vehicle bumper.

Most the state-of-the-art parking support sensors currently deployed are based on ultrasound technology. This approach has an inherent drawback, in that sensors integrated in the vehicle are visible. This is due to the nature of ultrasound propagation properties, where the bumper material does not allow for propagation of the ultrasound in an easy and usable manner. Furthermore, the external operation unit must procure additional processing power to provide accurate parking support information tithe driver. Well-established ultrasound technology systems achieved huge production maturity and a low system cost.

Alternative solutions for parking support could be mm-wave radar systems, which are currently deployed mainly for long distance obstacle detections. In these operation modes, they must have high gain antennae, which implies larger size and other special features related to beam forming, tracking and object identifications. State of the art mm-wave radar IC structures in automotive frequency bands usually have 2 transmit chains and 4 receive chains. The cost of such system with antenna and the assembly is high, with mm-wave IC typically realized in SiGe BiCMOS technology. Integrated PLL and technology transfers to CMOS are currently being announced, to be designed on product level. Millimeter-wave radar systems could be integrated in the vehicle bumper, but having communication losses and system topologies of mm-wave sensors and methods of operation, not allowing the low system production cost. At least not low enough to be a valuable replacement path for the ultrasound sensors. The number of transmit and receive channels is too high, antenna systems are integrated with other technology as radar package itself, MM-Wave RF IC package is integrated in the module by using bonding wires to the PCB or flip chip approach to the state of art interposer structure.

The following published patents and patent applications show the relevance of the topic and the state-of-the-art in respect to mm-wave integrated sensor systems.

DE 102012201367, “The millimeter wave radar” introduces a millimeter-wave radar device with at least one millimeter wave circuit and at least one antenna, constructed as a module of a multi-layer multi-polymer board.

U.S. Pat. No. 7,782,251, “Mobile millimeter wave imaging radar system” introduces a shortrange complex millimeter wave imaging radar system, having scanned Tx and Rx antennae.

U.S. Pat. No. 9,583,827, “Millimeter-wave radar” is introducing a module having a multilayered multipolymer circuit board for module, with classic PCB for mm-wave applications.

U.S. Pat. No. 9,386,688, “Integrated antenna package” is introducing an interposer for the packaging module based on microstrip feed lines and lenses, for mm-wave applications.

U.S. Pat. No. 8,460,967, “Integrated antennas in wafer level package” s is introducing packaging concept with integrated circuit (IC) chip embedded Within a package molding corn pound with a molding compound package layer coupled to an interface layer for integrating an antenna structure and a bonding interconnect structure to the IC chip.

WO2016204641, “Millimeter-wave sensor system for parking assistance” is introducing parking sensor concept based on obstacle angle detection, combined with FMCW radar application.

### SUMMARY OF INVENTION

This invention proposes an Apparatus 100 and its Method of Operation for inherently low-complexity and low-cost topology mm-wave radar sensor, targeting as a major application field vehicle parking support. Apparatus 100 is advantageously used being integrated in the vehicle, more precisely having integration in the lateral part of the vehicle 1, and 4 as well integration in the bumper part of the vehicle 2.

Apparatus 100 and its method of operation provide the following operations features:
1. Detection of the obstacle distance;
2. Ability to be integrated in vehicle bumpers, being unnoticeable, in contrast to ultrasound sensor systems
3. Ability to have the complete apparatus size with antennae, analog IC parts and digital parts less than 30 mm×15 mm×5 mm, where 5 mm is thickness much smaller as state of art ultrasound transducers.
4. Optional ability to determine whether the obstacle is a living being, like a human or animal;
5. Optional improvement of the distance and accuracy toward obstacles by collaborative information processing of more than one Apparatuses 100, used on the same vehicle platform.

For the abovementioned features 1-4 all necessary calculation measures can be performed by Apparatus 100 itself. Optionally porting of the processing features 1-4 and processing feature 5, may be conducted in the dedicated vehicle calculation entity 700, which be part of the central vehicle processing entity 800, which process all the sensor information in the vehicle.

The choice to use the mm-wave frequency band (30 GHz to 300 GHz) and advantageously to use 60 GHz band and 77-81 GHz band is mainly related to the size of the antenna system, allowing small and compact device, even though high-gain antenna with more than one radiation element is used. Millimeter-wave front end preferably operates in:
77-81 GHz automotive regulatory dedicated mm-wave band;
60 GHz ISM Band, under short-range device regulation, allowing the worldwide usage without dedicated frequency band allocation;
Higher ISM band mm-Wave ranges.

The proposed system has a technical capability supporting different operation modes or their combination:
a) Mode one: Detection of the distance to obstacles using FMCW radar type of the operation, where the apparatus transmits and receives the frequency ramped signal, with the bandwidth between 500 MHz and 4 GHz, with an option to extend the PLL and VCO bandwidth to 10 GHz.
b) Optional mode two: In this mode the proposed apparatus is working in CW Mode, in a dedicated frequency within the frequency band of Apparatus 100 operation, detecting received power level.
c) Optional mode three: In this mode the proposed Apparatus works in CW Doppler Mode, in a dedicated frequency within the frequency band of Apparatus 100 operation. One antenna is transmitting 22 and antenna 21 is receiving the reflected signal. In the Digital processing entity 40, the signal is analyzed to detect the possible vibrations related to the detection of a living being, or detection of the specific predefined moving pattern, being labeled for specific pre-defined event.
d) Optional mode four: In this mode, more than one Apparatus 100 system is integrated in the vehicle, typically in the vehicle bumper, with their operation coordinated by the additional computation and control unit, that may be part of the vehicle's computer system application portfolio, where the physical connection to the external entity is realized by connection options 60.
e) Optional mode five. Different Apparatuses 100, integrated in the same vehicle platform, to be operating in different time slots, by operating in FMCW mode for distance detection.
f) Optional mode six. Different Apparatuses 100, integrated in the same vehicle platform, to be operating in same time slots, and using the same frequency ramp, being time synchronized, where at least one sensor is operation is working in FMCW mode sending the date and at least one of the apparatuses are receiving captured FMCW signal and calculated distances.

The key system relevant components of the proposed apparatus 100 are:
Planar antenna system, realized by a plurality of technologies and approaches, with one transmitting 22 antenna system and one receiving antenna system 21, where the related antenna systems 21 and 22, are high gain antenna systems having each antenna gain in 10-16 dBi ranges, providing asymmetrical radiation partner in perpendicular axes, with radiation 3 dB angle in azimuth being larger than 45 degrees, and radiation angle in elevation being smaller than 45 degrees.
Millimeter-wave radar with integrated front end on silicon 10, System on Chip, analog processing of the mm-wave signal, where the following entities are included:
   Fractional N PLL—Phase Locked Loop 605 with VCO Voltage Control Oscillator, providing ability to generate multi GHz ramp frequency sweep signal and signal frequency in band of operation;
   PA Power Amplifier 606 with PA power control, feeding TX antenna 22;
   IQ Demodulator 607 for down conversion of the signals;
   Signal conditioning blocks 609, providing signal filtering and power amplification to get the proper power level values for interfaces ADC converter 30, without external conditioning components;
   DC Voltage regulator and circuit biasing 601, which may be integrated in the entity 513, instead of entity 10
   Test circuitry 602 for integrated IC, operation, production and functional safety testing;
   Calibration entity 603 with digital and analog means, to influence and adjust the performance on analog parts in case of semiconductor process variations and temperature;
   Digital interface to digital processing entity 40 and control functionality 41, which is realized preferably by SPI protocol standard;
   DC supply connections 601;
   Antenna connections for receiving antennae 21 and for transmit antenna 22
   Optional iq demodulator 600
Digital signal processing functionality 40, with at least two analog inputs, having a standardized physical digital interface 60, with a plurality of realizations; where entity 60 may contain one or more entities 61, 62, 63 or 64.
Mechanical assembly with power supply interface to power supply infrastructure, containing a mechanically integrated antenna, digital and analog functionalities.
Supporting circuitry 50 as a part of Apparatus 100 include functionalities like mechanical connections of Apparatus 100 to vehicle parts and optional environment protection structure to protect Apparatus 100.
Optional delayer 610

The proposed apparatus and method of operation allows the production of the complete sensor system in the cost range significantly lower than 5€, per piece, for higher quantities, which is presented as one or more orders of magnitude cost difference compared to current state of the art long and medium range radar sensor solutions. This is possible by using the proposed innovative system approach for Apparatus 100, having special low complexity integrated circuitry, innovative antenna systems, innovative concept for Apparatus 100 integration and innovative integration implementation solutions, without PCBs and without specific antenna substrates.

Antenna systems 21 and antenna systems 22, are realized each as a 4×1 strings of the wideband radiation monopols 517, or wideband radiation elements dipoles 510, in both cases with reflection plane, being integrated advantageously in the polymer based package. Preferable solution with mm-wave dipoles, being released in conjunction with planar coplanar line feeding 518 and 519, is dramatically reducing manufacturing complexity of the mm-wave module, by requesting a simple metallization plane, for Apparatus 100 integration.

Antenna system 21 and 22 are realized as a first implementation option 510 by the four dipoles each having two planar metal parts 511 and 512, printed on single metal layer 502 realized with shape of metallized planar circle angle cut, from its center, with the angle larger than 60 degrees, and smaller than 120 degrees and the circuit radius, larger than 0.3 and smaller than 0.5 of the wavelength related to the middle frequency of operation. In this realization option the four dipoles are fed by coplanar lines 515 and 516.

Antenna system 21 and 22 are realized as a second implementation option by the four monopole antennas 517, comprising circuit angle portion with the angle larger than 60 degrees, and the circuit radius, larger than 0.3 and smaller than 0.5 of the middle of the frequency operation bandwidth. In this realization option the four monopoles are fed by the microstrip feeding lines 519, microstrip line power divider, without state of art quarter wavelength transformers, using tapered microstrip lines, requiring two metallization layers 502, and 518.

Classic FMCW architecture suffers from several sources causing a non-wanted frequency component at low frequencies and therefore limiting minimum range of detection to tens of centimeters, due to difficulty to distinguish them from the beat frequency coming from the received signal reflected from the observed target.

Millimeter-wave radar on silicon 10 is going to be used for ultra-short and short-range applications, preferably 0 m-15 m and therefore will be equipped with techniques which overcome system related FMCW radar detection drawbacks for ultra-short range distances.

Millimeter-wave radar on silicon 10 contains optionally used IQ modulator 600 between VCO 605 and power amplifier 606. The IQ modulator is going to shift the TX signal frequency before sending the chirp out. Thanks to this, when doing the mixing in IQ demodulator the nominal beat frequency is going to be higher for a known offset, removed from an area of transmitter to receiver leakage and interference leakage, and easier for filtering out and detecting.

Apparatus 100 can optionally contain a delayer 610 on receiving path, by the plurality of the realization options outside entity 10, or inside entity 10 or partly inside and partly outside of the entity 10. This line delays received signal and effectively shifts the beat frequency up, which is a same effect as caused by the IQ demodulator 600.

Apparatus 100, may be advantageously placed on the distance X, where X is smaller than 20 cm beyond the contact distance of the bumper. This special and innovative positioning of the Apparatus 100 inside the bumper will allow that the distances between the contact surface of the car bumper and very near object are detected with better accuracy. On the other side the tradeoff is done regarding degradation in the maximum detection distance with the same Apparatus 100, being positioned just behind the contacted surface.

### BRIEF DESCRIPTION OF DRAWINGS

FIG. 1 presents the typical application scenarios for vehicle parking assistance using the proposed Apparatuses 100. The apparatuses are integrated in vehicle structures like bumpers 2, lateral side of the vehicles 1, 4 being not visible or recognizable by the human eye, and having radiation and observation diagram in elevation 3.

FIG. 2 presents Apparatus 100 functional block diagram.

FIG. 3a presents Apparatus 100 hardware system concept lateral views, with dipole based antenna systems with two metallization layers, and mechanical interface option.

FIG. 3b presents Apparatus 100 hardware system concept 3D views, with mechanical interface option.

FIG. 3c presents Apparatus 100 hardware system showing details of the system, with mechanical realization option 505, with antenna radiation elements options 511 and 512 and DC supply lines 517 in the same metallization plane 502.

FIG. 4 presents Apparatus 100 hardware system with sub-system layer structure relevant to the Apparatus 100 manufacturing process, showing one metal layer 502 to be integrated with active and passive components: 10, 513, 514, 50 as well as 504 connections between active components and metallization layer 502, and radiation reflection layer 501.

FIG. 5a presents apparatus 100 hardware metal layer 502 with dipole based antenna systems, with feeding lines 515 and 516, radiation elements 512 and 511 and DC supply lines 517 for active parts 10 and 514 being realized in the same single metallized layer 502.

FIG. 5b presents apparatus 100 hardware close look of the dipole based antenna systems on the layer 502 and its physical connection with entities 504 to the active 10, 513, 514 and passive entities 50.

FIG. 6a presents apparatus 100 hardware system concept lateral view, with monopole based antenna systems, and mechanical interface option 505, having one shaped metal layer 502, one radiation reflection layers 501 and second metallization layers 518.

FIG. 6b presents apparatus 100 hardware system concept, with two 3D views and monopole based antenna systems, using monopole radiation elements 520.

FIG. 6c presents Apparatus 100 hardware system showing details of the system, with mechanical realization option 505, with antenna radiation elements options 520 and DC supply lines 517 in the same metallization plane 502 and with second ground plane 518, required for microstrip line feeding network 519.

FIG. 6d presents apparatus 100 hardware metal layer 502 with monopole based antenna systems, with microstrip feeding lines 519, radiation elements 520 DC supply lines 517 for active parts 10 and 514 being realized in the same single metallized layer 502.

FIG. 7 presents Apparatus 100 digital processing functional blocks.

FIG. 8 presents Apparatus 100 with two RX chains enabling angle detection.

FIG. 9 presents position of the Apparatus 100, within the bumper positioned displaced behind the bumper surface.

FIG. 10 presents Apparatuses 100, within the vehicle infrastructure with control and processing unit 700, which may be integrated in the central vehicle sensor processing and control processing unit 800.

FIG. 11 presents Apparatus 100 dipole antenna arrangements with even feeding structures and different radiation elelments.

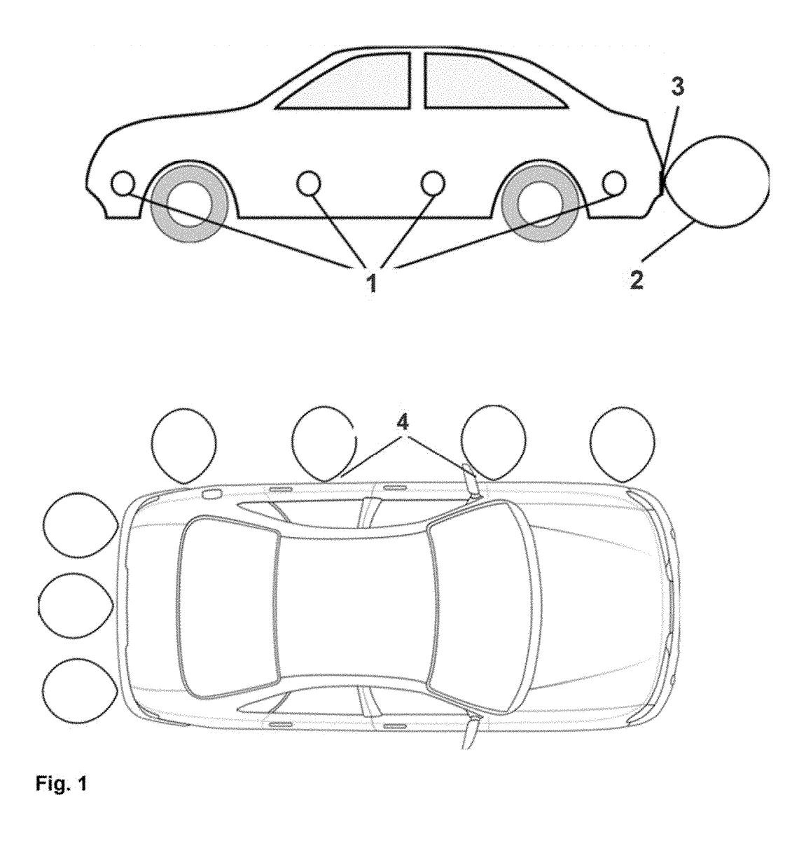

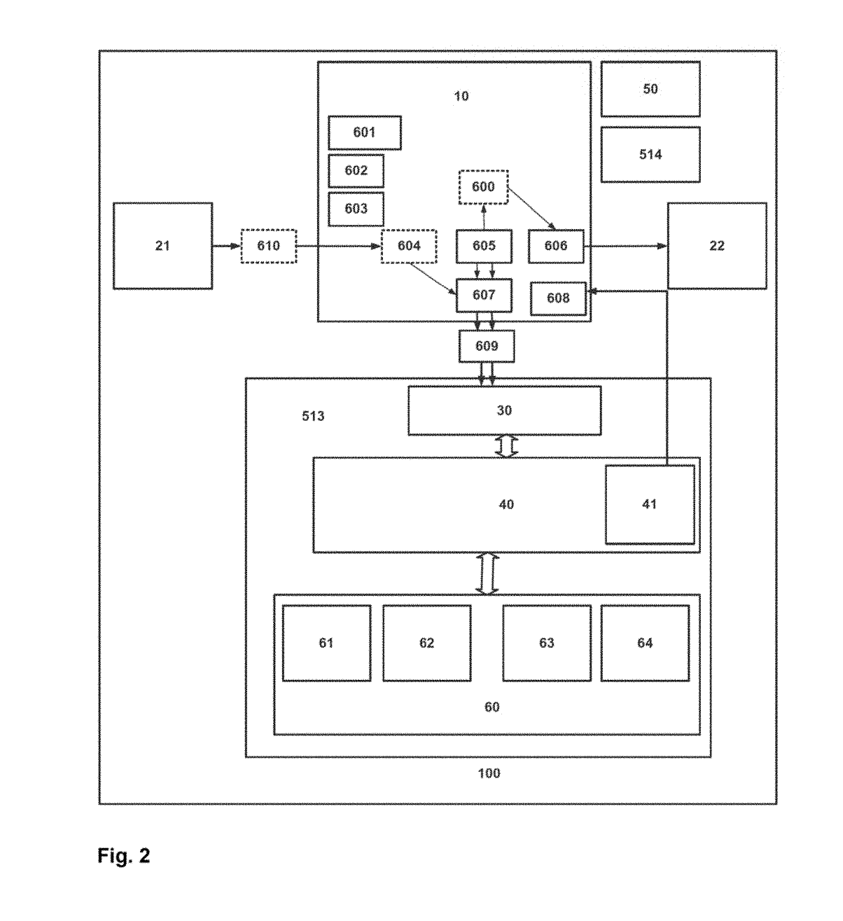

### DESCRIPTION OF EMBODIMENTS

The proposed apparatus 100 performs calculation of the distance, and received power level. The Apparatus 100 allows additionally and optionally to explore the parking obstacles vibrations, or specific moving patterns, being able to detect a living being, or specific pre-defined event, respectively.

Apparatus 100 enables three different modes of radar operation:
FMCW operation for distance calculation
CW mode for parking obstacle angle calculation, with sets of power detectors and optional
Doppler type of operation in CW mode, for vibration detection.

The proposed invention has in entity 10 fractional N PLL being able to address the complete frequency band of operation, being regulatory allocated for the operation the devices. In case of automotive frequency band 77-81 GHz, the PLL is addressing the full 4 GHz bandwidth, which allows high resolution bandwidth, also without special digital processing techniques. Through frequency ramp bandwidths of up to 10 GHz, in mm-wave frequency band, the resolution may be further improved and is practically realizable within entity 10, but would require a dedicated formal regulation approval for operation in a specific geographic location. The topology of the radar conversion chain has a down conversion mixer, where the frequency ramped VCO, signal is mixed with the reflected signal and where the distance detection is realized using FMCW principles. The down converted signals are filtered in the way to cut the harmonics and the filter structure is shaped with dedicated predefined filter, of M^{th} order, where M is higher than 3. In practice, 5^{th} Chebishef Low Pass filter is applied. The DC chain is followed by further signal conditioning circuitry, like a gain controlled low frequency amplifier, providing the signal in the right range to be acquired by entity 30 AD converter and further processed by entity 40, using FMCW state of art processing procedures. The power amplifier of entity 10, has gain control being arbitrary realized allowing operation in the complete band of interest, like the 77-81 GHz frequency band. The gain control of the entity 605, is essential for the near object detection that appears in parking procedures.

The entity 10 does not have necessarily a low noise amplifier (LNA) 604 structure, known in state of art FMCW radar systems. The received signals are provided advantageously to the IQ demodulator without LNA 604.

The power amplifier gain control allows power level reduce of the transmitted signals, which will provide mixer structures to work without saturation. After down-conversion, the signal is passed through a conditioning circuitry to provide right signal magnitude range for the AD cot version functionality 30 and to be properly filtered.

There is a high probability that the radar parking sensors will be integrated inside in the vehicle environment like vehicle bumpers: front and rear area, as well as on vehicle side areas, inside bumpers or similar. The basic aim of the proposed invention is to provide radar sensor topology giving more operation and functional features compared to the commonly used ultrasound systems, by being invisibly embedded in the vehicle, in contrast to current parking sensor and having inherent capability to compete in the realization cost with ultrasound parking systems.

In contrast to vehicle long and middle range radar applications, the proposed approach is different in not requiring a steering antenna beam of high gain antenna approach. The system requirement however, would preferably consider less antenna bandwidth in elevation, due to radar reflections from the ground and more coverage bandwidth in azimuth. On the other side, the size of the antenna should be as small as possible to enable easy handling vehicle integration and low cost.

In general, PA level and related power control is chosen to cope with the:
Frequency operation at 77-81 GHz, coping with radar sensor automotive regulation
Operation distance of 5 cm to 8 m
With resolution bandwidth related to 4 GHz frequency ramp, allowing after processing resolution in cm range
Environmental losses due to integration in the vehicle environment, like bumper
Tx and Rx Antenna gains in the range of 12 dBi, using preferably four radiation elements
Assembly transmission losses in antenna connection and feeding network of about 1-2 dB

PA power levels in the range of 10 dBm is addressed.

The Apparatus 100 can detect the object's distance using FMCW principles.

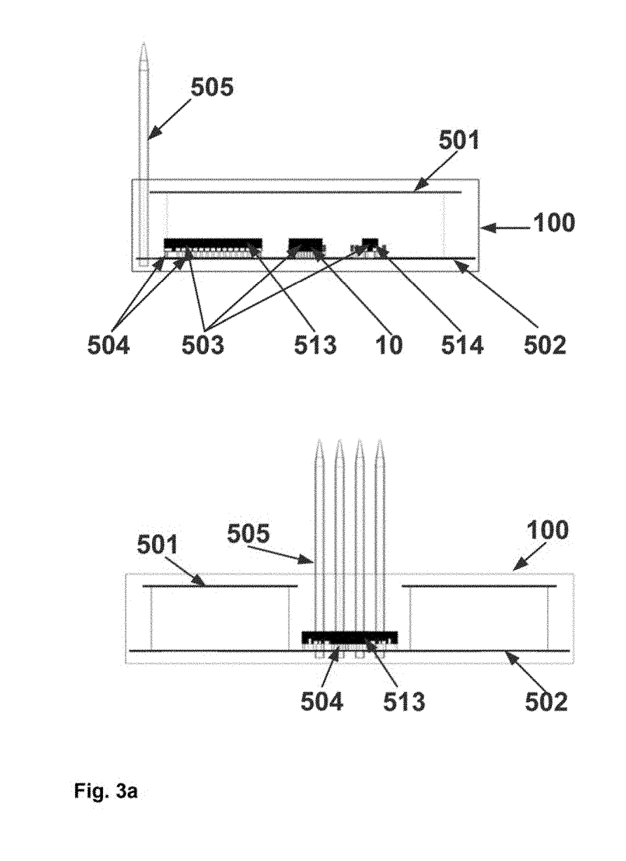

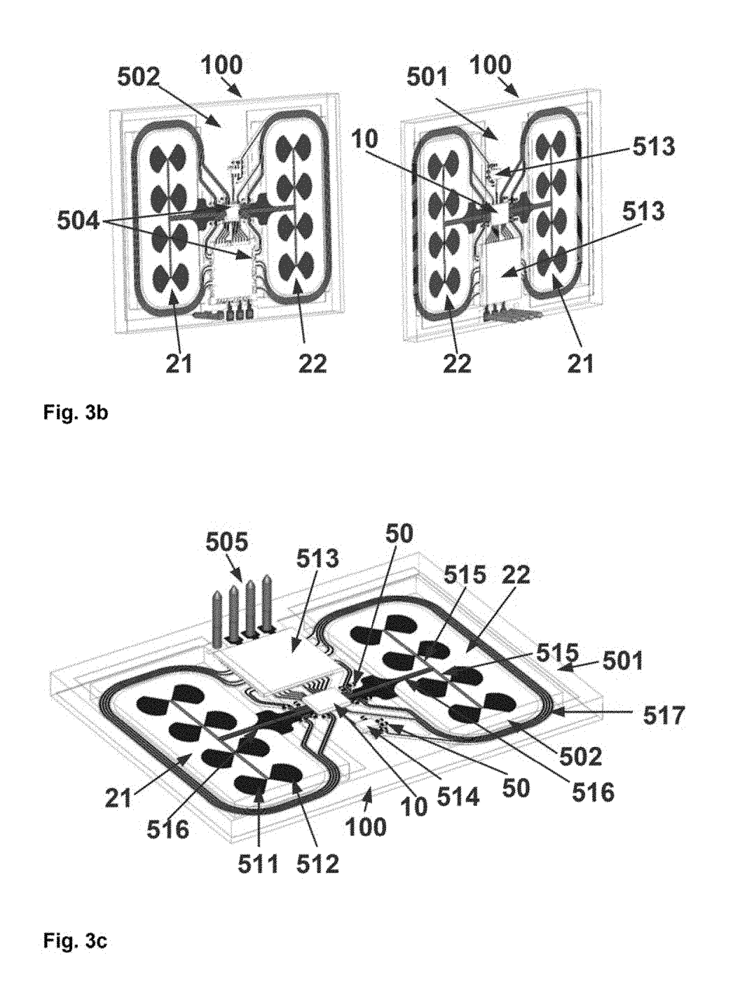

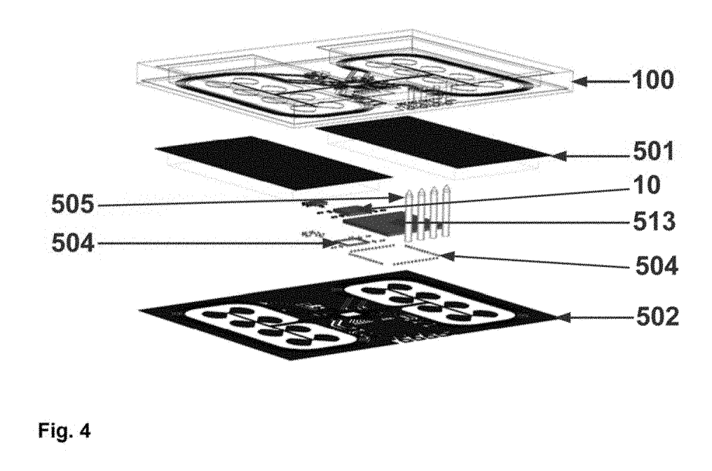

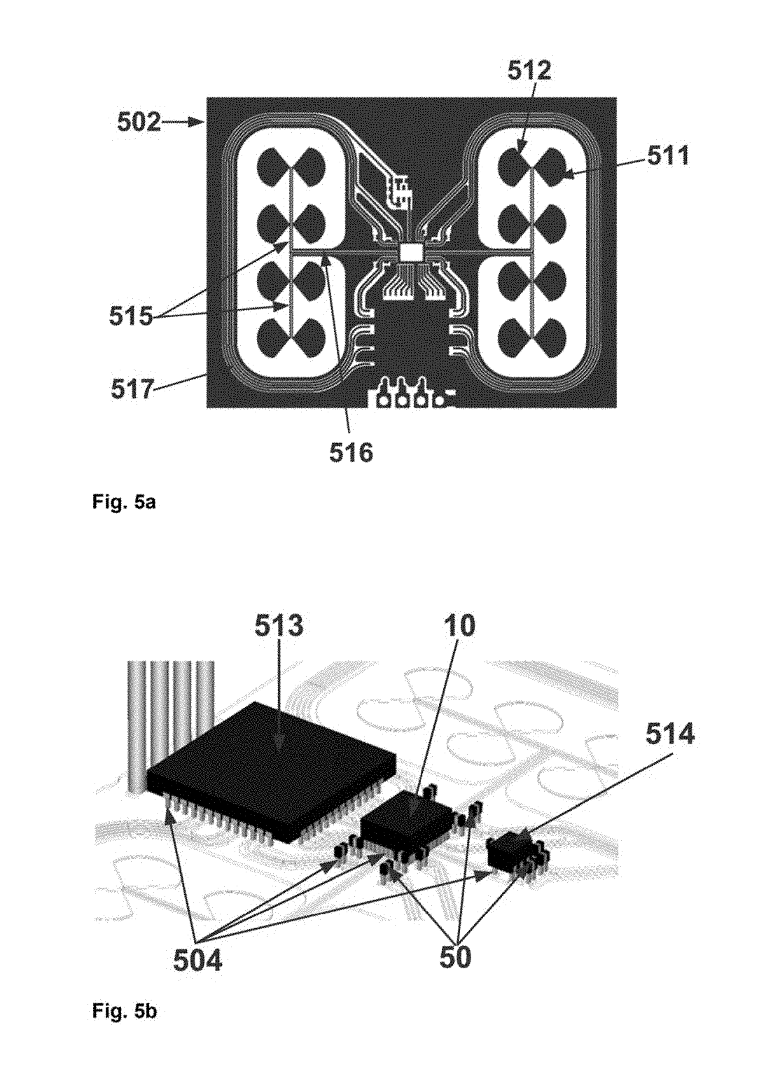

The lateral view of the proposed apparatus 100 realization option shows different stacks of the apparatuses. On top of the apparatus 100 we have antenna reflector 501 as a apart of the miniature module show on the FIG. 3a as a lateral view. Printed antennae with their feeding network is in the metallization layer 502. Between 501 and 502, we have an empty space with the distance around quarter wavelength +/−10% of the center frequency of the operation, providing reflection in one half space. Integrated circuits 503, are placed below metallization layer 501, and connected by vertical metallization entities 504. MM-wave transitions to the mm-wave integrated front ends and antennae are the critical factor influencing direct cost of the system, performance and production yield. Vertical metallization entities can be realized by the plurality of the technologies, depending of the applied technology for Apparatus 100 integration. Preferred integration option is polymer based integration of the Apparatus 100, in that case the entities 504, may be realized as metallic vias, circular or rectangular vias, which may be part of the metalized dielectrics. They are realized as short as practically for manufacturing possible, to minimize parasitic reactive effects on the antenna feeding, which cause losses like in case of the state of art bonding wires connections. In the case that semiconductor process is used for the connections 504 realization, 504 has 2-5 μm height full metal, preferably copper, connections. Entity 505 represents metal connections, wired connections, of the Apparatus 100 to the outside environments. Preferably metal non-isolated male pins are provided being integrated in the Apparatus 100. Those pins are connected to the female connector with attached cables of the vehicle infrastructure. The entity 505 represent state of art connections for automotive industry, has preferably 4 pins, two for DC supplies and two for data exchange. Further system enhancement and cost reduction, would be that the date transfer is performed over the DC supply pins, as a power line communication solution, which however suffers from EMC vulnerability. The FIG. 3b and FIG. 3C are showing 3D outlook of the Apparatus 100 realization, as thin black box with metallic pins, and with metallization layer 502, respectively. One of the metallization layer realization option for the antenna systems 21 and antenna system 22 are observed in FIG. 5a and FIG. 5b, as dipole antenna solutions 510. Antenna solution 510 may be observed on the top view of the metallization layer 502, of the FIG. 5b in more details. The antenna system 510 system consist of dipole antenna each having one dipole part 511, and second dipole part 512 being in the same metallization plane. The shape of one dipole part may be realized arbitrarily as an ellipsoid, as a rhomboid, as a pentagon and as n-tagons with axial symmetry, or the combination of n-tagons closer to the feeding point and an ellipsoid part in the upper part of the radiation element. Preferably 511 and 512 are realized in the shape as a planar metal circuits cuts, from its center, with the angle larger than 60 degrees, and smaller than 120 degrees, and the circuit radius, larger than 0.3 and smaller than 0.5 of the wavelength related to the middle frequency of operation. Second realization options introduced changed shapes of 511 and 512. This approach allows further reduction on antenna system sizes like shown in the FIG. 11. 511 and 512 are realized with shape of metallized planar circle angle cut, from its center, with the angle larger than 60 degrees, and smaller than 120 degrees, and the circuit radius, larger than 0.3 and smaller than 0.5 of the wavelength related to the middle frequency of operation, being further cut by its elements left and right edges by circuit segment, with added rectangular part, with height d taking non-negative values. Preferably height d can take values, smaller than 0.3 of the wavelength related to the middle frequency of operation. MM-Wave RF IC 10, is accompanied by the digital entity 30 and 40 on one SOC entity 513, tact reference 514 and support circuitry 50 items. Digital ASIC entity 513 comprises, besides ADC, analog digital converters, optional DACs, digital analog converters, interfaces 60, also CPU unit for digital processing, hardwired logics speeding ups some processing steps, as well as LDOs, for providing specific voltage levels required for 10, 514 and own functionalities, by concerting voltage levels coming from the vehicle. The entity 513 is realized preferably by CMOS technology, and can be integrated in the entity 10, in the case that entity 10 is realized by the CMOS technology too. Support circuitry 50 items are capacitors providing specific signal blocking. To provide the smallest possible production cost for the Apparatus 10, the number of the support circuitry 50 items, is to be as low as possible. Antenna feeding is advantageously realized by coplanar lines 515 approaching each of the dipoles in one dipole to another dipole manner as shown on the FIG. 5b. Odd mode coplanar line feeding 516 is coming from unbalanced connections of the mm-wave chip 10, via entities 504. Preferably the coplanar junctions between one 516 entity and two 515 entities are realized as show in the FIG. 5b, providing power splitting of the signals in Tx antenna 21 and power adding of the signals in Rx antenna 22. Thickness of the middle strip of entity 516, and related slots widths of the entire 516, are chosen to provide the impedance matching with the outputs of the entity 10, incorporated influences of the entity 504. Characteristic impedances of the coplanar lines branches 515 are two times rages and characteristic impedance of the transmission line entity 516, before junction point. The thickness of the main strip of entity 516 and sloth weights before junction points can be optionally tapered, to provide slow transmission line matching, meaning changing of the characters transmission line impedance along the length of the entity 516, without frequency selective transmission line impedance changes. As observed in FIG. 5a and FIG. 5b active components 513 and 514 and 10, would need to have a DC supply. The related DC supply for the components, being in the range 1-4V, is provided through entity 513, vie sets of the DC & current transmission lines 517. Lines 517 are routed around metallic surface for the antennas, so that they do not significantly influence the radiation structure of the Apparatus 100. The proposed innovative approach of the signal printed metallic layer 502 containing antenna prints, specific very wide band operation dipole antennas and wide band frequency nonselective feeding structure, without any PCB and specific materials, are lowering complexity of integration approaches, providing high production yield of the Apparatus 100. The complete enclosure of the Apparatus 100 is preferably realized by one production run, enabling simultaneous provision of humidity, dust, temperature and ESD protection required for the parking application. Coating encapsulation of the polymer in the radiation direction of the Apparatus 100 do not significantly influences the quality of radiation, due to smaller losses. In the FIG. 4 functional layer structures of the integrated Apparatus 100 are observed. It is visible that the proposed integration structure has one metallization plane with antennas, feeding structures 502, one reflector plane 501, metal connectors 505, connection structures 504 being connected to the active entities 10, 513, 514 and passive elements, defined as circuitry 50, being integrated with dielectric and coatings with plurality of the realization options. Circuitry 50 is in figures represented by SMD blocking capacitors, or SMD resistors. Preferably, the full integration in 3D polymer approach with metallization layers and joined polymer integration of the entity 501 and 502 is considered for the implementation realization of the Apparatus 100 integration. The second realization options is semiconductor type of the metallic layer 502 integration with active components, with additional separate metallic shield 501 integration, followed than by the environment protection coating.

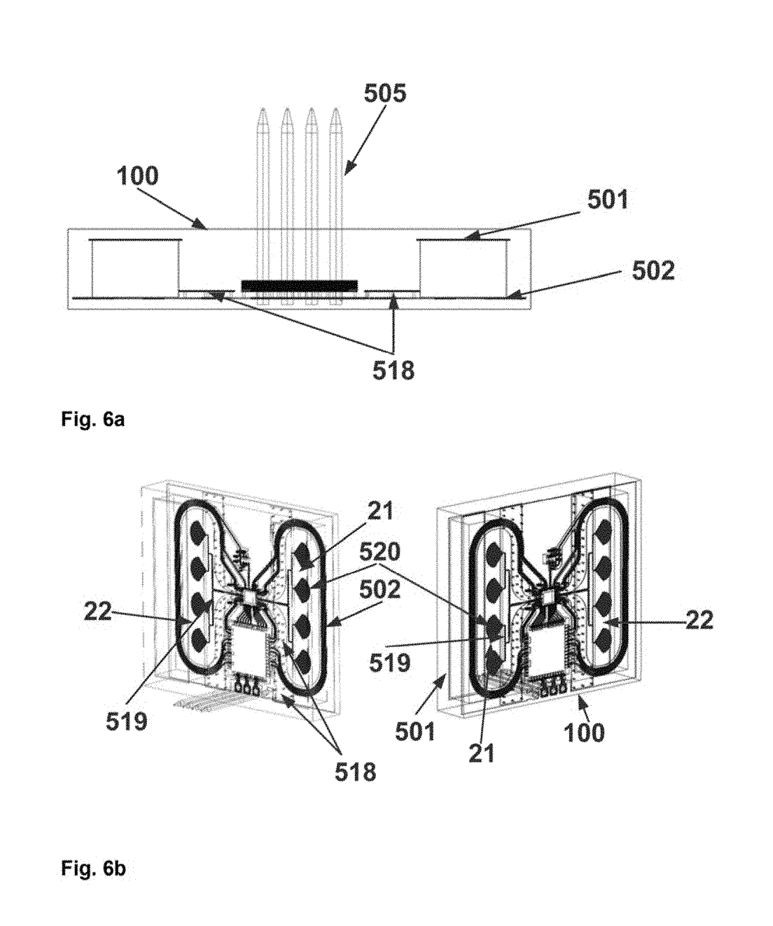

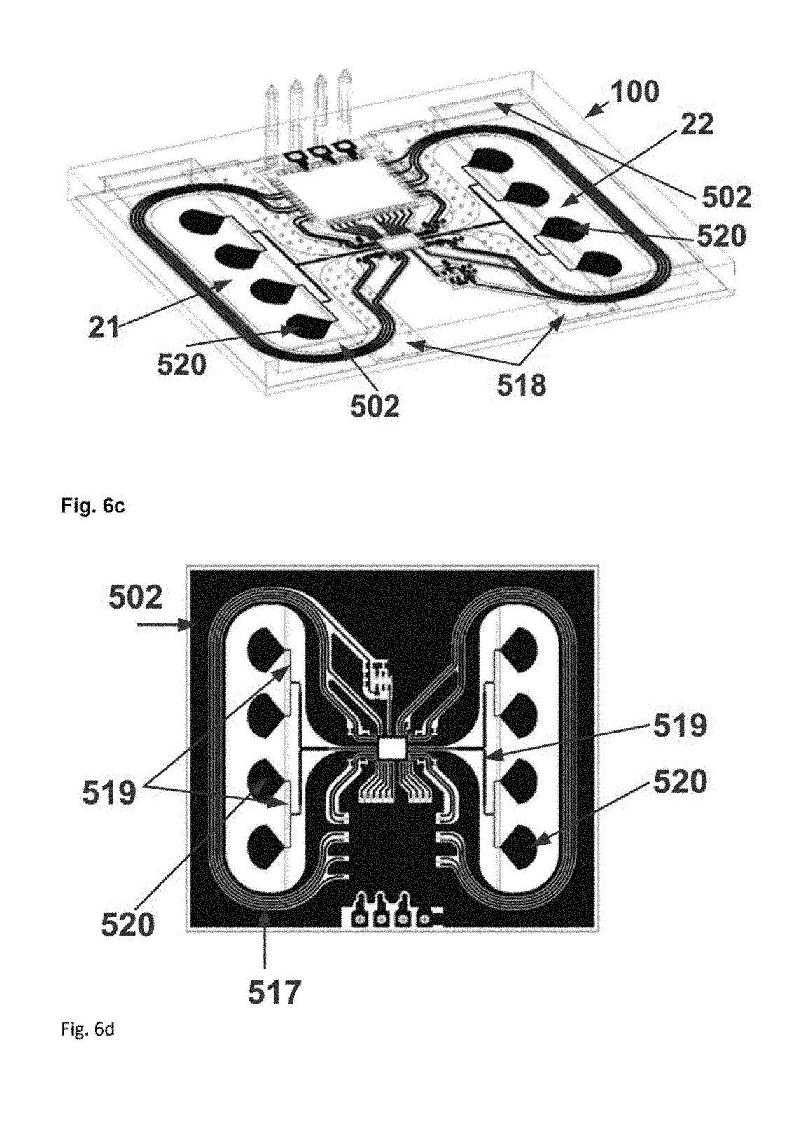

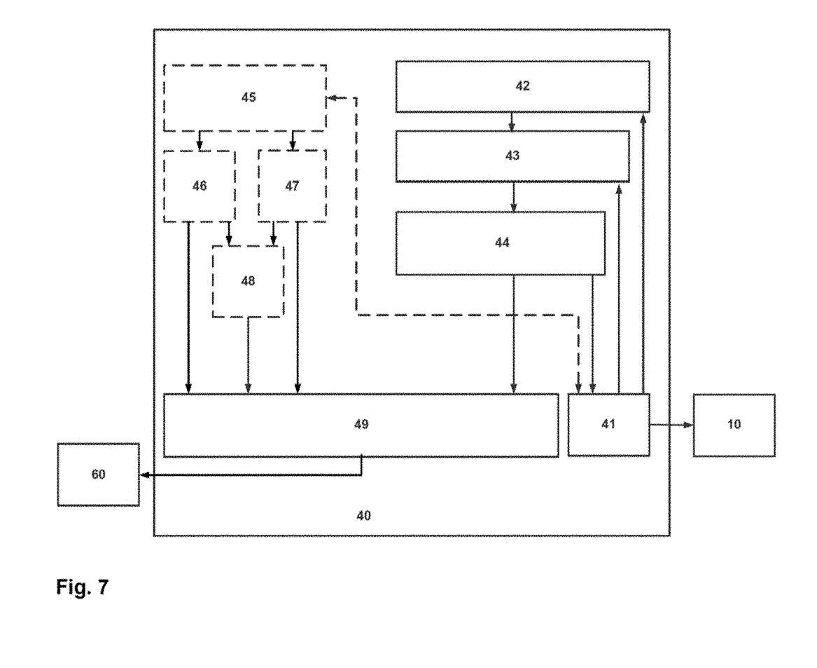

In FIG. 6a and FIG. 6b realization option of the Apparatus 100 is presented, where instead of using antenna systems realization options 510 with dipole antennas monopole type of the antenna 520 is introduced. The monopole 520 is realized in the shape as a planar metal circuits cuts, described as circuit angle portion with the angle larger than 60 degrees, and the circuit radius, larger than 0.3 and smaller than 1 wavelength of the middle of the frequency operation bandwidth. in this realization option the complete size of the system is smaller, about one wavelength in Apparatus width for a center frequency in operation, but on the other side additional metallization layer 518 is required to enable feeding of the monopole antenna by microstrip lines entity 519. If the production realization option for Apparatus 100 goes through semiconductor process type of the vertical metallization connections, introduction of the second metal layer will require usage of the additional metal musk and make the production of the system much costlier. If the 3D polymer integration is addressed this realization option can lead to the lower integration cost.

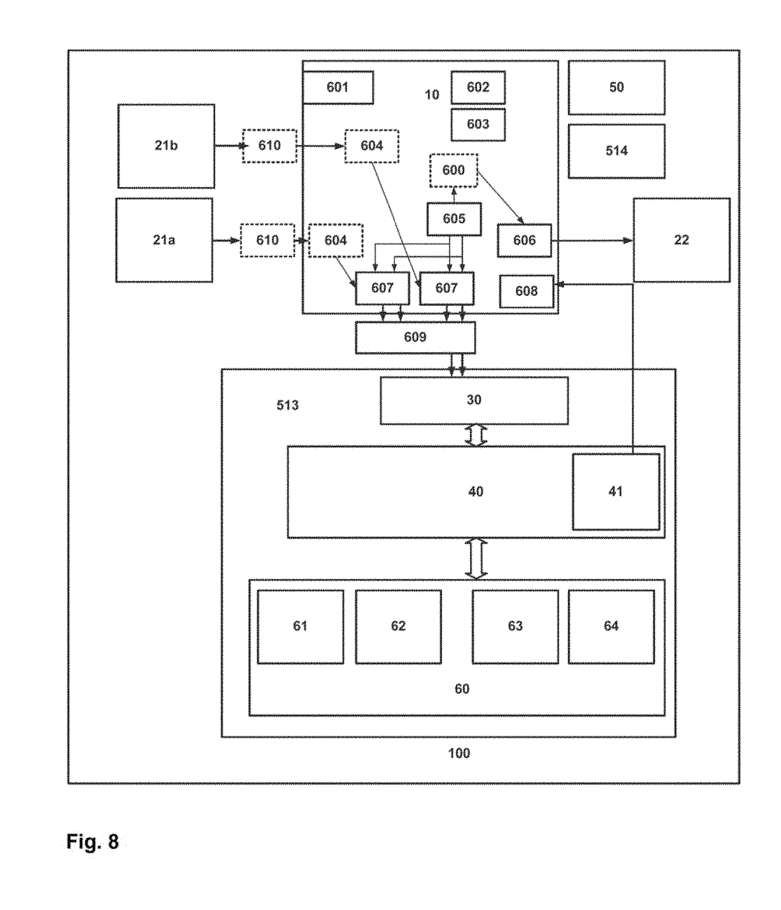

The mechanical structure is also connected by arbitrary realization means to the inside wall of the bumper, providing enough mechanical stability. It is proposed to positioned Apparatus 100 at the distance X, from the inside position of the bumper, where the X takes values below 20 cm. In the left section of FIG. 8, a mechanical positioning of the apparatus 100 support structure is presented. The choice of the distance is selected as a system trade of. On one side we have theoretical problems of the distance detection with radar system using FMCW radar principle for distances below 20 cm, with increasing distance detection inaccuracy and uncertain detection. By placing radar sensor at the distances, where X is larger than 0 cm, we may detect the objects with smaller distance than 20 cm to the outside boundary of the bumper. Theoretically if we would have distance X, of 20 cm, we would be able to detect the object very close or direct to the outside bumper surface with the bumper. On the other side we have parasitic reflections and from the environment enclosures close to radar before the radio ways approach the inside part of the bumper, which will require special signal processing solutions, and the maximum range will decrease. Therefore, the optimum value of the X is dependent on type of the plastic bumper, thickness, color metallization, mechanical environment inside the bumper, which is imposed by specific OEM vehicle type. Values between 3 cm and 10 cm seems to provide a decent tradeoff for large majority of the vehicles.

The entity 513 includes arbitrary digital wired interface like: CAN and/or LIN and/or SPI interfaces and/or proprietary digital interfaces, realized by the plurality of technologies, allowing easy connection to the world outside the Apparatus 100, with a cable connection. Due to cost pressure, it is likely that the CAN interface will be omitted and very low cost digital wireless interfaces will be deployed.

Means of short-range wireless connection to the vehicle system 63 are optional.

The wireless short-range communication interface 63 may be advantageously released by different wireless communication systems: Short range communication system (typically up to 2 km) having one or more of these wireless technologies: Short range 433, 866, 915 MHz low data rate, used commonly worldwide in communication systems, Wifi, or other 2.4 GHz and 5 GHz Band communication systems up to 200 meters, Bluetooth system, UWB Systems or other proprietary technology.

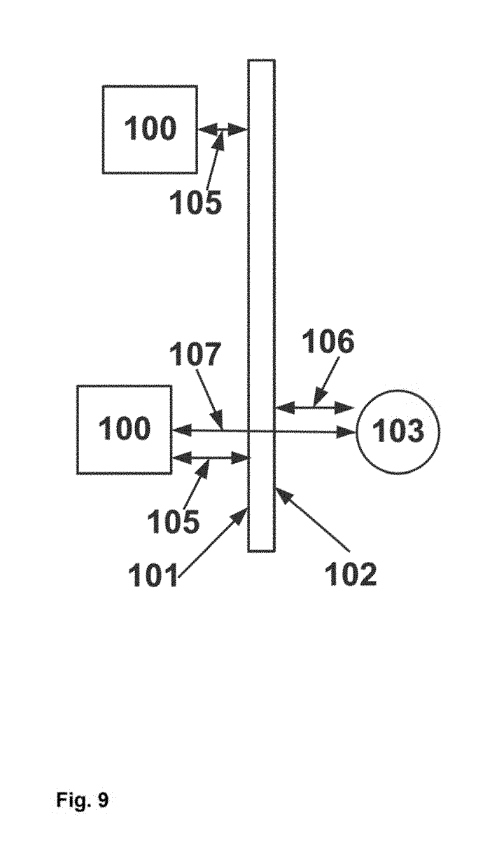

The information from more than one Apparatus 100 system is gathered in the entity 700, by using entity 60 features. In the apparatus in FIG. 9, there is DC supply and signal connectors to cables connecting the apparatus to an external computational unit 700. The external computational vehicle unit could be, but not necessarily the part of the vehicle central computation unit, with the role to provide:
Control of the Apparatuses 100 operation of all vehicles, as well as
Assessment of results coming out from all Apparatuses 100 being used in vehicle
Additional computation resources, related to the system relevant signal processing asses more Apparatuses 100 as well as optionally providing calculation for specific particular Apparatus 100, which internal digital computation means are limited in calculation performance.

In other to optimize the total system cost containing more than one apparatus in the vehicle, it could be decided to perform the calculation of obstacle distances by the apparatus itself, in case of Apparatus 100. In that case, Apparatus 100 would need to send very small amount of data to the external vehicle computational unit. This will require a decent portion of mathematical calculations in the Digital Processing Unit, which would require more processing power and potentially more memory. This will increase the cost of the Digital Processing Unit and the Apparatus 100 itself. On the other hand, the Digital Processing Unit 40 could perform a premature information handling and present it to the external computational unit 700. The information would need to be evaluated in the central vehicle's computational unit for all apparatuses connected to the system. In such case, more data needs to be transferred over the signal interface of the apparatuses and more data needs to be processed in the vehicle's computational unit. The system tradeoffs would need to be performed, to optimize the overall system cost. Less calculation on the digital processing size would allow better power dissipation handling within the apparatuses. It is however envisaged that the apparatuses will operate in low duty circle mode so that thermal dissipation should not be a problem.

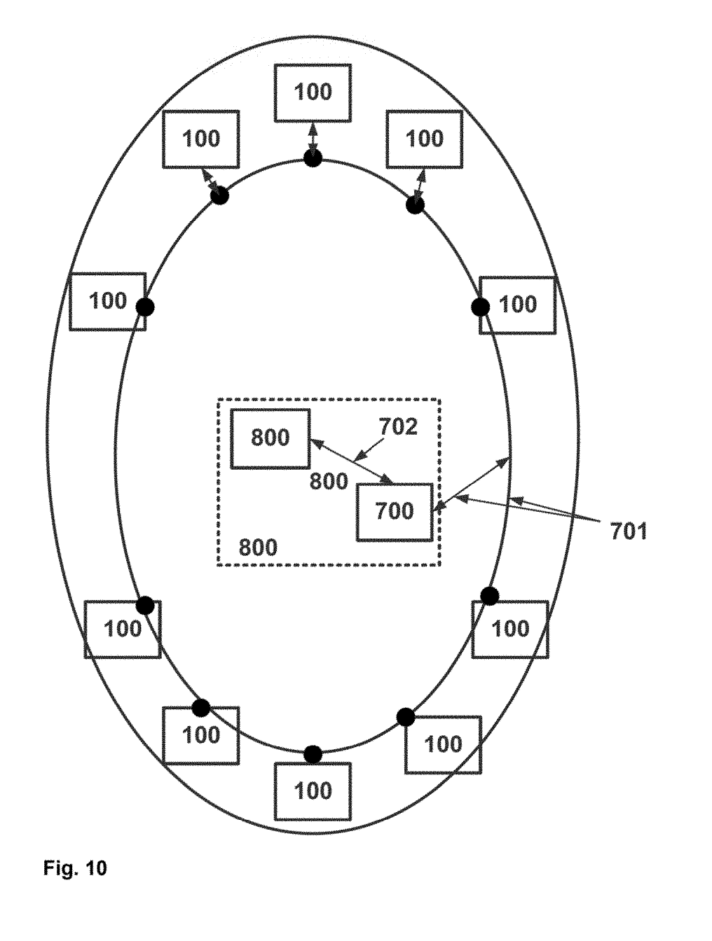

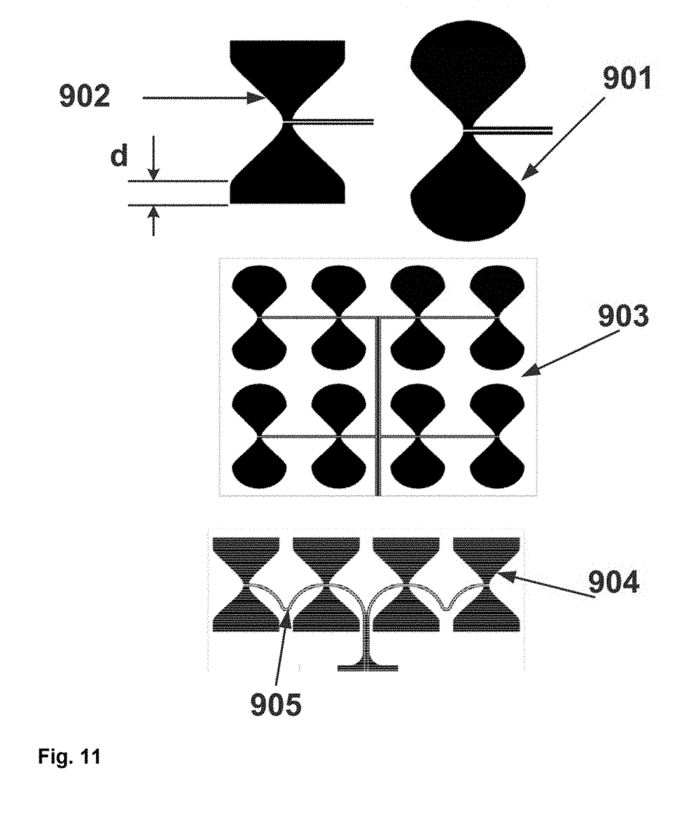

Digital Processing Functionality 40 of the Apparatus 100 contains controlling functionality 41. Controlling functionality 41, sets initialization of the Apparatus 100 operations modes, controlling all to be controlled functionalities of the Apparatus 100, after obtaining activity initialization from the external interface 60, from central vehicle control unit 700. Functionality 41 performs pre-defined system activities, including pre-set information of the duty circle operation of the Apparatus 100, and system monitoring functions, including enabling pre-defined procedures for functional safety sub-system test operation, and test status feedback initiation over entity 60 to the entity 700. Entity 42 performs digital filtering of the incoming IQ digitalized input signals, by the arbitrary, algorithm pre-set procedures, which may differ related to the signal strength being detected on the receiver chain 21. Distance detection entity 43 utilizes FMCW principle for detection of the distances, with the plurality of the FMCW algorithm realization options, and plurality of the used frequency ramps shapes, time durations, and frequency bands for sweeping. Preferable FMCW detection principle is utilized, switch on and switch off, for the specific pre-defined time slots in the distance calculation. That means when the calculation of the distance is performed, calculation of the distance is performed in limited time to overcome non-linearity problems in the entity 10, which may cause the decreases of the accuracy in the distance calculation. Entity 44 is responsible for adjustment of entity 10 transmit power level, as well as for initialization of the optional injection of the IQ modulation of entity 605 generated signal in the entity 600, before approaching power amplifier entity 606. If the received power level or pre-history of the detection indicates that the object is close, which causes large power signal level at receiver input the transmit power may be decreased, to minimize non-linearity effects and better accuracy in the distance detection. If the calculated distance is below 20 cm, different effects related to FMCW detection principles and entity 10 imperfections appears. This leads to dramatic accuracy degradation or even non-ability to detect the distance at all. To make the calculation of the distances below 20 cm, entity 44 initialize optionally the IQ modulation of the signal by entity 600. The modulation signal is chosen in the way that the virtual time delay is introduced, allowing FMCW detection of the distance being virtually extended in conjunction to the extension of the virtual delay of the FMCW signals, so that the calculation of the virtually extended distance is performed in the area where the system related effects and imperfections of the entity 10 does not influence loss of the accuracy. Alternatively, or additionally physical delay line structure 610, may be optionally introduced by the plurality of the realization options. Both entities 610 and 600 are introducing additional actual or virtual delay in the signal path. These approach cause additional signal processing efforts in the entity 42, which are also initialized by the entity 44 over entity 41, if the actual measurement distances are tending to be in the 20 cm range or smaller. Optionally entity 44 is initializing the optional additional angle detection and its calculation in addition to the distance calculation by the FMCW principle. This requires that the Apparatus 10 has two receiver chains meaning two receiver antennas 21, and two IQ demodulators 607, as well extended analog digital conversion capability of entity 30, with 4 analog channels to sample instead of two, like shown in the FIG. 8. This means that if the two Apparatuses 100 at positioned at the pre-defined distance in the bumper are detected two distances to the object, position of the object, angles may be calculated and provided to the system for the driver information or autonomous driving control, which is especially important for parking where we have as an object with smaller reflection surface. If each Apparatus 100, would have an optional angle detection, this may improve the accuracy of the system. On the other side this would increase the Apparatus 100 cost, due to large silicon size of the entity 10, and additional signal processing efforts. Entity 45 introduces optional initialization of the doppler mode operation of the Apparatus 100. That means that the entity 10, will in the entity 605 initialize CW operation, instead of frequency ramping for FMCW operation. In the entity 45 calculation of the doppler frequencies are performed, by the arbitrary frequency based analyses, which may include analysis in the frequency domain, by enabling implementation of the entity 45 partly in the hard wired FFT digital processing, with associated additional digital filtering options. Entity 45 also provides motion pattern pre-filtering required for the entity 47. Optional entity 46 realized the vibration analysis using frequency transformed doppler data being provided by the entity 45. Specific digital windowing and pre-defined filtering is applied to extract useful information vibrations of the object under observation, vibrations of the vehicle, or vibrations being related to the human being. Optional entity 47 provides motion pattern extraction provided by digital data from entity 45, where the data represents pre-filtered time domain data and pre-filtered frequency data signals required for mapping motion patters to the pre-defined cases of the motion patters, being related to the specific events. Those events may be different art of the sudden intrusion in the front of vehicle, or different pattern of the short-range radar observations being acquired during the driving, in front, with some angle and fully lateral to the vehicle movements. If the doppler data and distance date are gathered from lateral vehicle sensors, those Apparatuses may use this data for the environment mapping and for SAR radar data collection of the lateral environment, which on other side provides additional information for autonomous driving, and other useful commercial applications. Entity 47 may perform this digital processing local on Apparatus 100 or prepare the data for the extern processing on the entity 700, through entity 49. The Information from entity 47 is provided to the entity 48 and for the entity 49. Optional entity 48 analyses vital signs of the signal being provided by the entity 46 or entity 47, doing classification of the signals and mapping it to the different live being categories, like specific animals or human beings. Entity 47 may perform this digital processing local on Apparatus 100 or prepare the data for the extern processing on the entity 700, through entity 49. Entity 48 provides information to the entity 49. Entity 49 is gathering the information from optional entities 43, 44, 45,46, 47, 48 by direct and indirect means, and provides information collection, framing of the data, sorting of the information in the predefined data cluster generation, to be provided to the entity 60, and then from entity 60, by arbitrary wired protocols means to the entity 700. As seen in the FIG. 10 entity 700, can be functional entity being integrated in the vehicle central computed unit 800. Two realization options are possible, all Apparatuses 100 are connected by arbitrary wired communication protocols means 701, or arbitrary wireless communication means over each Apparatus 100 entity 60, with one entity 700 processing and communication unit. Entity 700 is being responsible for parking sensor control and system operation. Entity 700 is than connected by arbitrary wired communication protocols means 702, to the central vehicle processing and controlling unit 800. In this scenario a complete set up of the apparatuses 100 and as well as physical hardware of entity 700 as one parking system unit is optimized for specific vehicle environment and as such integrated in the vehicle, In the second scenario entity 700, as an embedded SW block with defined SW application interfaces, is integrated in the central vehicle sensor and control processing unit 800. In that scenario a complete set up of the apparatuses 100 and as well as SW entity 700, to be further integrated in the entity 800, as one parking system unit is optimized for specific vehicle environment and as such integrated in the vehicle.

The entity 700 can gather the simultaneous observation information from all Apparatuses 100 being integrated in the vehicle environment, and calculate and construct 2D mapping of objects and of obstacles in the vehicle surrounding. This 2D map may be provided to the entity 800, which may be used to the integrated HMI interaction initialization, and visual information to be delivered to the people in the vehicle.

FIG. 11 shows different antenna arrangement to be addressed for the antenna solution of the Apparatus 100. Dipole 901 fed by coplanar line can be realized in the similar realization option 902. Entity 902 has angular part identical like entity 901, and upper part is constructed by circuit segment cut and rectangular portion add on with the thickness d. Thickness d takes values of zero or larger than zero. Entity 902, is realized with smaller planar dimension, and may be used for the overall Apparatus size dimensions reductions, without influencing radiation diagrams. In the entity 905, approached for reducing a dipole antenna string size based on 901 elements is shown, with vertical dimension reduction and horizontal reductions, by introducing meandering coplanar lines. Entity 903 shows approaches of realized a high gain antenna concepts with 8 dipoles and signal coplanar feeding. Those entities may be very usefully for the radar applications addressing seat occupation application, driver fatigue, baby detection and monitoring as well as emotion sensing.

Apparatuses 100 being integrated in the lateral portions of the vehicle can be used for the environment lateral observation, when the vehicle is not moving and when the vehicle is moving. The lateral information gathered through distance calculation of the environment, in the conjunction with the vehicle movement with known speed, can be used for the SAR (Synthetic aperture radar) type of the radar environment scanning. This information may be further used as data, or may be used for the comparison with the pre-defined environment data, having assotiated geographical data, like GPS coordinates.

The imperfection of the entity 10, is leading to the RF signal coupling and current leakages inside of the integrated mm-wave system on chip. This corresponds to the gaussian like distribution of the parasitic bit frequency noise at the end of the IQ demodulator chain, which may make the distinction of the reflection based bit frequency peak related to the close distances of the object to the Apparatus 100 making distance detection very difficult. It is proposed that digital processing functionality 40 is performing dedicated signal processing measures, by the plurality of the algorithm solutions, to minimize the influences of the parasitic noise to the bit frequency detection, which will result in better accuracy of the detection distances. Since the frequency noise distribution is known, and since it is time invariant, not changed in time, specific signal processing techniques may be applied. Possible mechanism model to be addressed in algorithmic solutions is that the portion of the output TX power is added on the top of the VCO signal to be mixed with the incoming signal with other portion of the TX input signal jointly generating bit frequency with errors.

1. Sensor Apparatus, based on contactless sensor operation using mm-wave frequency bands between 30 GHz and 300 GHz, comprising of:
1. High-gain planar antenna system for transmitting mm-wave radio signals, having at least one string of more than 3 radiation elements, where the elements are realized as a coplanar line fed point dipoles, having more than 15% operation bandwidth of the central frequency of operation, where each dipole has two radiation parts, with where each radiation parts are designed on the same plane, and where the complete antenna system feeding network is realized with metallization in the same plane as antenna parts, having single two ground and one hot wire coplanar line connections to the integrated mm-wave circuit transmitter part,
2. High gain planar antenna system for receiving mm-wave radio signals, having at least one string of more than 3 radiation elements, where the elements are realized as a coplanar line fed point dipoles, having more than 15% operation bandwidth of the central frequency of operation, where each dipole has two radiation parts, with where each radiation parts are designed on the same plane, and where the complete antenna system feeding network is realized with metallization in the same plane as antenna parts, having single two ground and one hot wire coplanar line connections to the integrated mm-wave circuit receiver part,
3. Integrated mm-wave radio front end, implemented in arbitrary semiconductor technology, having on-chip integrated mm-wave voltage control oscillator, mm-wave power amplifier, digital control interface, power supply; fractional N PLL enabling FMCW with frequency ramping and CW operation with fixed frequency, IQ demodulator, signal conditioning analog circuitry with voltage gain control at lower frequency and analog filtering structures by lower frequency, with arbitrary realization options;
4. Analog to digital conversion entity, with at least one analog digital conversion entity
5. Digital processing functionality, including controlling functionality, and calculation and memory capacity for performing digital signal processing by arbitrary type of the realization options;
6. Interface to entity outside of Apparatus, by the plurality of the realization options, and plurality of the communication protocols, and comprising N wired interfaces, where N is an integer number larger than 1, providing DC supply and data exchange connections;
7. Supporting circuitry, including a mechanical interface to the environment, as well as smaller passive and active components inside the module;
8. Radio frequency reference, providing analog reference signal with high phase noise purity in the frequency range below 250 MHz
9. Conducted reflector plane integrated at the distance of +/−10% of quarter wavelength of the center frequency from the plane with antenna radiation elements
where the complete Apparatus is realized as module:
without PCB structures,
without bonding wires inside module,
without interposer
without flip-chip structures inside the module, being integrated using:
3D structures of the dielectrics with different properties
metallization layers
cavities
where
only one 2D shaped metallization layer is existing in the Apparatus and one metallization layer for antenna radiation reflection.

2. Sensor Apparatus, described in claim 1 where:
1. High gain planar antenna system for transmitting mm-wave radio signals, having at least one string of more than 3 radiation elements, where the elements are realized as a monopole antennas, having more than 15% operation bandwidth of the central frequency of operation, where each monopole has one radiation part, designed on the same plane, as microstrip lines for antenna system feeding, with tapered microstrip line power dividers, being connected to the mm-wave integrated circuit transmitter part
2. High gain planar antenna system for receiving mm-wave radio signals, having at least one string of more than 3 radiation elements, where the elements are realized as a monopole antennas, having more than 15% operation bandwidth of the central frequency of operation, where each monopole has one radiation part, designed on the same plane, as microstrip lines for antenna system feeding, with tapered microstrip line power dividers, being connected to the mm-wave integrated circuit receiver part,
where
one 2D shaped metallization layer is existing in the Apparatus, one metallization layer for antenna radiation reflection, and one metallization area providing ground for microstrip line distribution network for feeding monopole antennas.

3. Apparatus according to the claim 1 and claim 2, where DC supply lines for the active elements being in the Apparatus, are realized by the plurality of the implementation options in the same plane as radiation elements of the antenna systems.

4. Apparatus according to previous claims, when the one part of the dipole antenna introduced in the claim 1, and one monopole antenna introduced in claim 2, are realized with shape of metallized planar circle angle cut, from its center, with the angle larger than 60 degrees, and smaller than 120 degrees, and the circuit radius, larger than 0.3 and smaller than 0.5 of the wavelength related to the middle frequency of operation.

5. Apparatus according to previous claims, when the one part of the dipole antenna introduced in the claim 1, and one monopole antenna introduced in claim 2, are realized with shape of metallized planar circle angle cut, from its center, with the angle larger than 60 degrees, and smaller than 120 degrees, and the circuit radius, larger than 0.3 and smaller than 0.5 of the wavelength related to the middle frequency of operation, being further cut by its elements left and right edges by circuit segment, with added rectangular part, with high d taking non negative values.

6. Apparatus according to previous claims, when the mm-wave integrated radio circuit contains IQ modulator.

7. Apparatus according to previous claims, when the apparatus is placed at the specific distance from inside plane of the bumper, which is larger than 0 cm and smaller than 20 cm.

8. Apparatus of claim 5, wherein there is a delayer in RX path, either inside or outside of the mm-wave integrated circuit, realized by plurality of technologies, which is configured to process fixed delay time and generate beat frequency offset.

9. Apparatus according to previous claims, when the Apparatus has mm-wave integrated circuit with two identical receiver chains, with the same VCO feeding IQ parts, with two receiving antenna systems, being able to detect angle of arrival and to calculate distance by using FMCW approach, with the same hardware.

10. Apparatus and System as described in the previous claims, where apparatus, performs the distance calculation using FMCW principles, in the way that the observation window for the distance calculation is selected,, being smaller as the theoretical observation window, not to include time window portions, where the non-linear effects, near the signal picks appear.

11. The system having more than one Apparatuses, according to previous claims, when Apparatuses are connected by arbitrary communication means to dedicated control and signal processing unit, having real timer processing capability for parking system relevant events, by using information from more than one Apparatuses, being further connected to the vehicle central computation unit by arbitrary communication means, which provides further sensor information fusion and processing relevant for driver interaction and autonomous driving.

12. The system according to the claim 10, where dedicated control and signal processing unit, is integrated as a software functional block in the vehicle central computation unit.

13. The system according to the previous claims, where two adjacent Apparatuses, with predefined mutual distance, are providing information for distance to the objects, which is used to calculate position of the object, with trigonometric calculation, using arbitrary numerical methods, by the dedicated control and signal processing unit, having real time processing capability for parking system relevant events.

14. The system like in claim 12, where apparatuses are providing besides distance information also angle information to the object to dedicated control and signal processing unit, having real time processing capability for parking system relevant events.

15. like in previous claims, where Apparatus is working in Doppler mode, sending CW frequency, receiving reflected signals, which are IQ mixed with CW frequency, providing information about moving pattern of the object, to the internal digital processing unit.

16. like in claim 15, where the system described in claim 10 and claim 11 is performing the digital processing to extract if the moving pattern under detection is matching pre-defined sets of the moving pattern profiles, each corresponding to the pre-defined event.

17. like in claim 14, where the system described in claim 10 and claim 11 is performing the digital processing to perform the vibration analysis to detect the live being, by detecting respiratory pattern, each corresponding to the pre-defined respiratory event.

18. like in previous claims where the information gathered through vehicle environment integrated Apparatuses is processed by the dedicated control and signal processing unit, providing real time 2D vehicle surrounding mapping information of all associated objects distances, close to the vehicle, to the central vehicle processing unit.

19. like in previous claims, where at least one of the Apparatuses are used for lateral to the vehicle movement environment observation, providing SAR radar mapping of the environment.

20. The apparatus of claim 19 where the information captured by at least one of the lateral observation Apparatuses is used for comparison with pre-stored environment data, associated with specific geographical location.
